(19) United States
(12) Patent Application Publication
(10) Pub. No.: US 2025/0199539 A1
(43) Pub. Date: Jun. 19, 2025

(54) METHOD, COMPUTER PROGRAM AND APPARATUS FOR DETERMINING AN ACTION FOR AN AUTOMATED DEVICE BASED ON UNCERTAINTIES OF A STATE OF AN ENVIRONMENT OF THE AUTOMATED DEVICE

(71) Applicant: Sony Group Corporation, Tokyo (JP)

(72) Inventors: Peter DÜRR, Jona (CH); Sam Robert Allan BLAKEMAN, Zurich (CH)

(21) Appl. No.: 18/847,254

(22) PCT Filed: Mar. 29, 2023
(86) PCT No.: PCT/EP2023/058096

§ 371 Date: Sep. 15, 2024

(30) Foreign Application Priority Data
Mar. 31, 2022 (EP) 22165905.5

(51) Int. Cl. G05D 1/606; G05D 1/243; G05D 107/70

(52) U.S. Cl. CPC G05D 1/606; G05D 1/243; G05D 2107/70

(57) ABSTRACT

Examples relate to a method, a computer program and an apparatus for determining an action for an automated device based on a state of an environment of the automated device. A method for determining an action for an automated device based on a state of an environment of the automated device. The method comprises obtaining information on environmental measurement results, the measurement results having a limited confidence; estimating information on a state of the environment based on the information on the environmental measurement results, the information on the state of the environment comprising information on a confidence of the state of the environment; determining a representation for the state of the environment based on the information on the state of the environment and based on the information on the confidence of the state of the environment, the representation of the state of the environment comprising two or more intermediary states representing the state of the environment and the confidence of the state of the environment; and determining information on the action for the automated device based on the representation.

### FIELD

Examples relate to a method, a computer program and an apparatus for determining an action for an automated device based on a state of an environment of the automated device, more specifically, but not exclusively, to a concept for enabling statistical information for a determined action of an automated device.

### BACKGROUND

Artificial intelligence and machine learning concepts have been developed and applied to many different technical fields, e.g. in the field of autonomous vehicles or industrial robots. For example, training data is used to train a neural network for its later purpose, wherein a later performance of the trained neural network also depends on the quality of the training and quality of the training data. Trained neural networks provide their output based on inputs from the environment, e.g. based on sensor data from the environment. Some concepts make use of continuous learning or training, for example, reinforcement learning may use reward or other quality measures to judge decisions made by a neural network. Depending on the rewards or quality measures the neural network keeps learning about its decisions and therewith a continuous learning or training concept can be established.

### SUMMARY

Examples are based on the finding that statistical properties of environmental data can be used to improve the use of machine learning methods. For example, confidence information on the environment can be used to generate or determine an improved output of a neural network. It is another finding that a state of an environment can be represented using two or more intermediary states, which also represent statistical properties of the environment. Theses intermediary states can then be used to determine multiple actions or outputs of the neural network, which also have statistical properties. The statistical properties of the actions or output differ from the statistical properties of the environment because of non-linear operation of the neural network, for example, decisions are made by the neural network. Examples may provide improved actions or output based on using two or more intermediary states as representation of the state of the environment.

An example relates to a method for determining an action for an automated device based on a state of an environment of the automated device. The method comprises obtaining information on environmental measurement results, the measurement results have a limited confidence. The method further comprises estimating information on a state of the environment based on the information on the environmental measurement results. The information on the state of the environment comprises information on a confidence of the state of the environment. Furthermore, the method comprises determining a representation for the state of the environment based on the information on the state of the environment and based on the information on the confidence of the state of the environment. The representation of the state of the environment comprises two or more intermediary states representing the state of the environment and the confidence of the state of the environment. For example, the confidence of the state represents the strength of evidence in favor of each possible state. The method further comprises determining information on the action for the automated device based on the representation. Examples may enable determining an improved action by considering the representation of the environment, which is not only based on the state of the environment but also on the confidence of the state of the environment.

Further examples may also comprise determining confidence information for the action. The confidence of actions may enable further judgment or measures in a system, e.g. specific maneuvers in case of low confidence and improvement of training data.

For example, each of the two or more intermediary states comprises one or more sigma points representing statistical properties of the information on the state of the environment. The two or more sigma points may form a statistical basis for determining the action also based on the statistical properties of the environment.

The method may further comprise using one or more policies to obtain two or more intermediary actions based on the two or more intermediary states. The policies may implement a decision-making process and provide a non-linear transformation from the intermediary states to the intermediary actions. In examples, the policies may be implemented as a machine learning or neural network enabling decisions on actions.

For example, the method may use the same policy to obtain one intermediary action for each of the intermediary states. In examples, multiple copies of the same policy may be used in a bank of policies. That way, the same decision-making process can be used in parallel for the two or more intermediary states yielding in two or more intermediary actions. Moreover, the resulting distribution of the intermediary actions may represent the transformation of the distribution of the intermediary states by said policy. The distribution of the intermediary actions may serve as a basis for determining confidence information for a determined action.

For example, the policies can be subject to reinforcement learning or an evolutionary search. The one or more policies may involve a non-linear transform to obtain the two or more intermediary actions based on the two or more intermediary states. Hence, decision making processes may be implemented using the one or more policies. Therewith, the statistical properties of the intermediary states may be quite different from the statistical properties of the intermediary actions. Examples may enable a determination of the statistical properties of the intermediary action although the policies are non-linear. The method may further comprise determining statistical properties of a distribution of the two or more intermediary actions. This may enable judging a confidence on an action.

In some examples, the method comprises using an unscented transform for determining the statistical properties of the two or more intermediary actions. The unscented transform may enable an efficient means for determining the statistical properties of an outcome of a non-linear policy.

The determining of the information on the action may be further based on the statistical properties of the distribution of the two or more intermediary actions, and the statistical properties of the distribution of the two or more intermediary actions comprise confidence information on the intermediary actions. For example, the determining of the information on the action may be based on the confidence information of the intermediary actions.

At least in some examples the method may further comprise determining information on a safety action as information on the action if the confidence information for the intermediary actions indicates confidence levels of the intermediary actions below a predefined confidence threshold. That way, if the confidence of an action is too low, the situation can be detected, and a safety measure can be applied.

In further examples, further training of the policies may be applied, wherein the training of the policies is influenced by intermediary states identified for intermediary actions exhibiting a predefined statistical characteristic. For example, the predefined statistical characteristic is a confidence threshold.

The automated device may be an autonomous vehicle or an industrial robot and the action may be a controlled action for the autonomous vehicle or the industrial robot. The action may comprise or correspond to one or more elements of the group of a maneuver, a motion, an acceleration, a deceleration, a steering command, a stop command, and an emergency command. Hence, in examples an emergency command or a safety action may be a command to stop an automated device.

A further example is a computer program having a program code for performing any one of the methods described herein, when the computer program is executed on a computer, a processor, or a programmable hardware component.

Another example is an apparatus for controlling an automated device comprising a control unit or module for performing one of the methods described herein. Yet another example is an automated device, e.g. an automated or anonymous vehicle or an industrial robot, comprising an example of the apparatus.

### BRIEF DESCRIPTION OF THE FIGURES

Some examples of apparatuses and/or methods will be described in the following by way of example only, and with reference to the accompanying figures, in which

FIG. 1 shows a bock diagram of a flow chart of an example of a method for determining an action for an automated device based on a state of an environment of the automated device;

FIG. 2 shows a block diagram of an example of an apparatus for controlling an automated device and an example of an automated device;

FIG. 3 illustrates how a learned policy uses the state of the environment to determine the best action in an example;

FIG. 4 shows an example implementation using a state estimator to determine a point estimate of the current state as input for the learned policy;

FIG. 5 depicts an example using a set of sigma points from the estimated distribution of the state, which is fed to a bank of policies;

FIG. 6 illustrates how policies can first be trained in simulation with perfect state information and then deployed in the real world using a probabilistic state estimator in an example;

FIG. 7 shows a block diagram of a flowchart of an example implementation, in which after computing a distribution of actions using an unscented transform, the resulting estimate of uncertainty is used to select an action that accounts for the state estimate uncertainty;

FIG. 8 shows a block diagram of a flowchart of an example implementation, in which after computing a distribution of actions using an unscented transform, the resulting estimate of uncertainty is used to trigger an emergency stop;

FIG. 9 shows yet another block diagram of a flowchart of an example implementation, in which after computing a distribution of actions using an unscented transform, the resulting estimate of uncertainty is used to decide whether to commit to an action or wait for more state evidence; and

FIG. 10 shows a block diagram of a flowchart of an example implementation, in which after computing a distribution of actions using an unscented transform, actions that lie outside of the resulting distribution are used to bias further training of the policy.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

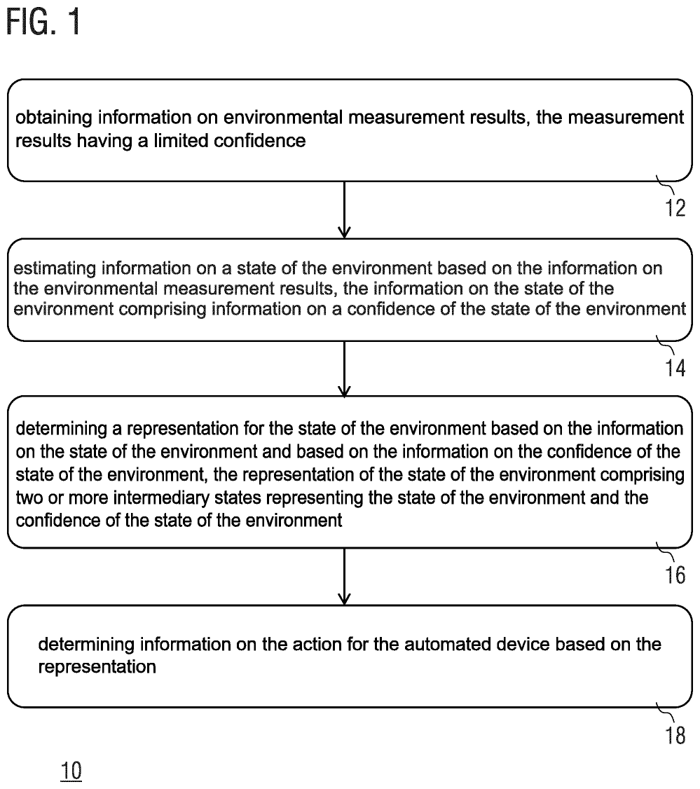

FIG. 1 shows a bock diagram of a flow chart of an example of a method 10 for determining an action for an automated device based on a state of an environment of the automated device. The method 10 comprises obtaining 12 information on environmental measurement results. The measurement results have a limited confidence. For example, the obtaining 12 may comprise sensing certain physical parameters or quantities in the environment, which are subject to noise and distortion. Such parameters may include, temperature, pressure, humidity, radiation, mechanical stress, etc. The obtaining 12 may also include receiving information, e.g., in terms of messages or digital information, on the environment, such as traffic or environmental information communicated between vehicles. Any such information about the environment may have a limited reliability or confidence.

The method 10 further comprises estimating 14 information on a state of the environment based on the information on the environmental measurement results. The information on the state of the environment comprises information on a confidence of the state of the environment. The confidence on the estimated state may depend on the confidence of the measurement results and the interrelation of the quantities determining the state of the environment. While in simulation or training a perfect state of the environment may be known, in the real world there always are uncertainties involved. Moreover, depending on the field of application the environment may be very time variant. The confidence of measurement result or information on the environment may deteriorate over time. That way sensing and processing times may also take effect on the confidence.

As further illustrated in FIG. 1 the method 10 comprises determining 16 a representation for the state of the environment based on the information on the state of the environment and based on the information on the confidence of the state of the environment. The representation of the state of the environment comprises two or more intermediary states representing the state of the environment and the confidence of the state of the environment. For example, the intermediary states may be determined or selected such that a mean of the intermediary states matches the state on the environment and a variance in the intermediary states matches or is based on the confidence on the information on the confidence of the state of the environment. The method 10 further comprises determining 18 information on the action for the automated device based on the representation. As will be further detailed subsequently, the action for the automated device may be determined based on a distribution or a confidence of the intermediary actions.

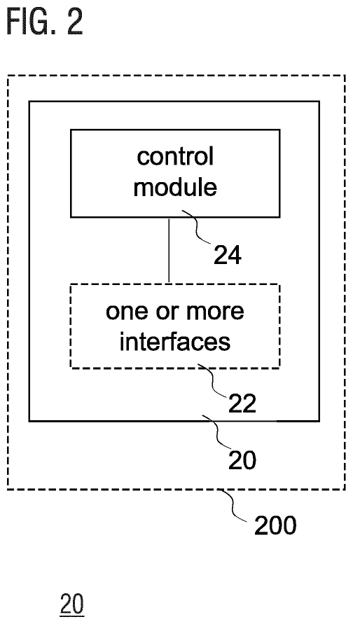

FIG. 2 shows a block diagram of an example of an apparatus 20 for controlling an automated device and an example of an automated device 200. The apparatus 20 for controlling the automated device comprises a control module 24 for performing one of the methods described herein. Optionally, the apparatus 20 comprises one or more interfaces 22, which are coupled to the control module 24 and which are configured to communicate with the environment, e.g. other devices, sensors, etc. Optional components are shown in broken lines.

As further illustrated in FIG. 2, the apparatus 20 may comprise one or more interfaces 22, which are coupled to the respective control module 24. The one or more interfaces 22 may correspond to one or more inputs and/or outputs for receiving and/or transmitting information, which may be in digital (bit) values according to a specified code, within a module, between modules or between modules of different entities. For example, an interface 22 may comprise interface circuitry configured to receive and/or transmit information. In examples an interface 22 may correspond to any means for obtaining, receiving, transmitting or providing analog or digital signals or information, e.g. any connector, contact, pin, register, input port, output port, conductor, lane, etc., which allows providing or obtaining a signal or information. An interface 22 may be configured to communicate (transmit, receive, or both) in a wireless or wireline manner and it may be configured to communicate, i.e. transmit and/or receive signals, information with further internal or external components. The one or more interfaces 22 may comprise further components to enable communication in a mobile communication system, such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly, adapted radio frequency components, etc.

The control module 24 may be implemented using one or more processing units, one or more processing devices, any means for processing, such as a processor, a computer or a programmable hardware component being operable with accordingly adapted software. In other words, the described function of the control/processing module 24 may as well be implemented in software, which is then executed on one or more programmable hardware components. Such hardware components may comprise a general-purpose processor, a Digital Signal Processor (DSP), a micro-controller, etc. A further example is an automated device 200, e.g. an automated/autonomous vehicle or an industrial robot, comprising an example of the apparatus 20.

Examples may enable an improvement by combining probabilistic state estimation methods with learned nonlinear control policies. For example, by applying an unscented transform to the probability distribution of the input to a learned control policy, one may obtain an approximate probability distribution of actions from which a better choice of action can be derived. For example, reinforcement learning (RL) enables the use of learned control policies in robotic systems. In classical RL, an agent, receiving a state from the environment, learns which actions to take by interacting with its environment driven by a reward signal.

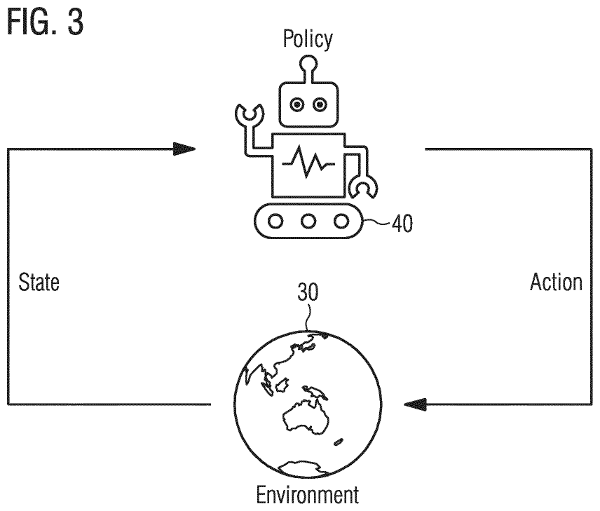

FIG. 3 illustrates how a learned policy uses the state of the environment to determine the best action in an example, Fig, 3 shows the environment 30 at the bottom and a policy 40 at the top. The policy 40 receives information on the state of the environment and decides on an action, which influences the environment. Hence, a learned policy 40 uses the state of the environment to determine the best action. One of the challenges in physical implementations of RL however, is how to incorporate the inherent uncertainty of the state signal from the environment. Whereas some implementations use an end-to-end approach, directly using measurements from sensors as an input to the control policy, many implementations employ probabilistic state estimation algorithms, such as recursive filtering (e.g., using extended Kalman filters, unscented Kalman filters, etc.) to estimate a Gaussian probability distribution of the current state.

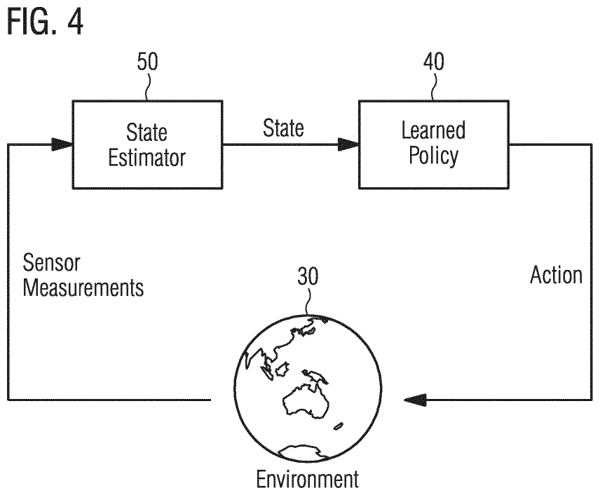

This probability distribution of the state is then used to derive a point estimate, usually the mean of the Gaussian distribution, which is used as an input to the learned control policy. FIG. 4 shows an example implementation using a state estimator 50 to determine a point estimate of the current state as input for the learned policy 40. This results in a single choice of action which a) does not reflect the uncertainty of the state estimate, and b) does not well approximate the optimal action for nonlinear policies.

Examples therefore use a representation of the environmental state, which make use of two or more intermediary states, which reflect the uncertainty of the state estimate. For example, an unscented transform (UT) may be used to approximate a distribution of actions, from which the preferred action can be derived. The method 10 then comprises determining confidence information for the action.

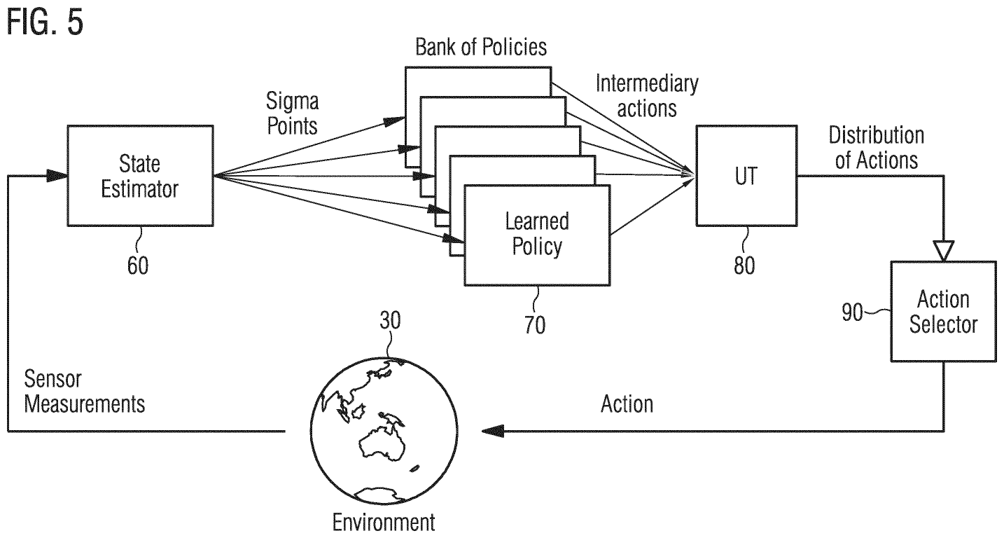

FIG. 5 depicts an example using a set of sigma points from the estimated distribution of the state, which is fed to a bank of policies. The state estimator 60 takes sensor measurements from the environment 30 and determines two or more sigma points. For example, each of the two or more intermediary states comprises one or more sigma points representing statistical properties of the information on the state of the environment. These sigma points are then provided to a bank of policies 70. The method 10 comprises using one or more policies 70 to obtain two or more intermediary actions based on the two or more intermediary states (sigma points). For example, the same policy is used to obtain one intermediary action for each of the intermediary states. The one or more policies 70 involve a non-linear transform to obtain the two or more intermediary actions based on the two or more intermediary states.

Given a probabilistic estimate of the current state, e.g., from a recursive filter in the state estimator 70, a set of sigma points is chosen for each of which the learned policy 70 is evaluated. The resulting point estimates are then combined into an approximate probability distribution of (intermediary) actions. In the example of FIG. 5 a set of sigma points from the estimated distribution of the state is fed to a bank of policies 70 (e.g. multiple parallel implementations of the same policy). The output of the policies 70 is then combined by the UT 80 into an approximate distribution of (intermediary) actions. An action selector 90 determines the action using this distribution. For example, a mean or median action of this distribution may be selected, and its variance may be used as confidence information.

As indicated in FIG. 5, the method 10 may further comprise determining statistical properties of a distribution of the two or more intermediary actions. In the example of FIG. 5, the method 10 uses the unscented transform 80 for determining the statistical properties of the two or more intermediary actions. Thereby, the example implements an unscented policy transform for learned control policies with uncertain inputs.

The determining 18 of the information on the action may be further based on the statistical properties of the distribution of the two or more intermediary actions. The statistical properties of the distribution of the two or more intermediary actions may comprise confidence information on the intermediary actions.

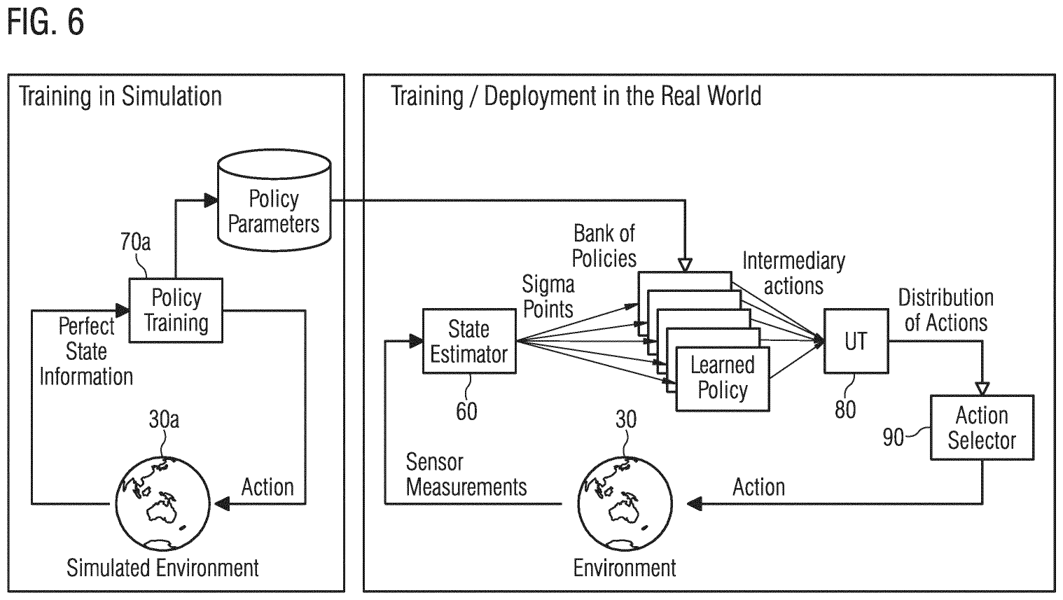

Using this setup, a policy can be trained using perfect state information in simulation, and then deployed in a real system using probabilistic state estimation, as further illustrated in FIG. 6. FIG. 6 illustrates how policies can first be trained in simulation with perfect state information and then be deployed in the real world using a probabilistic state estimator in an example. FIG. 6 shows a training environment on the left-hand side. A simulated environment 30a is used to generate perfect state information based on which policy training 70a is carried out. The outcome of the policy training 70a are actions, which in turn influence the simulated environment 30a. From the policy training 70a policy parameters 70b can be extracted and transferred to the bank of policies in the real-world deployment.

Policies 70 can first be trained in simulation with perfect state information and then deployed in the real world using a probabilistic state estimator 60. Examples may be implemented using hardware accelerators or hardware implementations of the control policy 70 and/or the state estimator 60.

Examples may offer benefits for deploying learnt RL policies in the real world, where there is uncertainty in the state estimate, examples may provide an improved action selection. Examples may allow for a better approximation of the best action by the learned control policy based on the uncertainty in the state estimate. Classical approaches feed a point estimate of the state to a single copy of the RL policy and execute the resulting action. However, the optimal action of the point estimate may be very different from the optimal action given the uncertainty in the state estimate. Examples therefore account for the uncertainty in the state estimate and how that affects the predictions of the policy. By using the unscented policy transform a set of sigma points can be passed to individual copies of the policy and the resulting distribution of actions can be observed. Then, an action can be picked from this distribution and be more confident that this action accounts for the uncertainty present in the state estimate. Importantly, due to the non-linearity of the policy, this action may be very different from the one generated by the point estimate of the state.

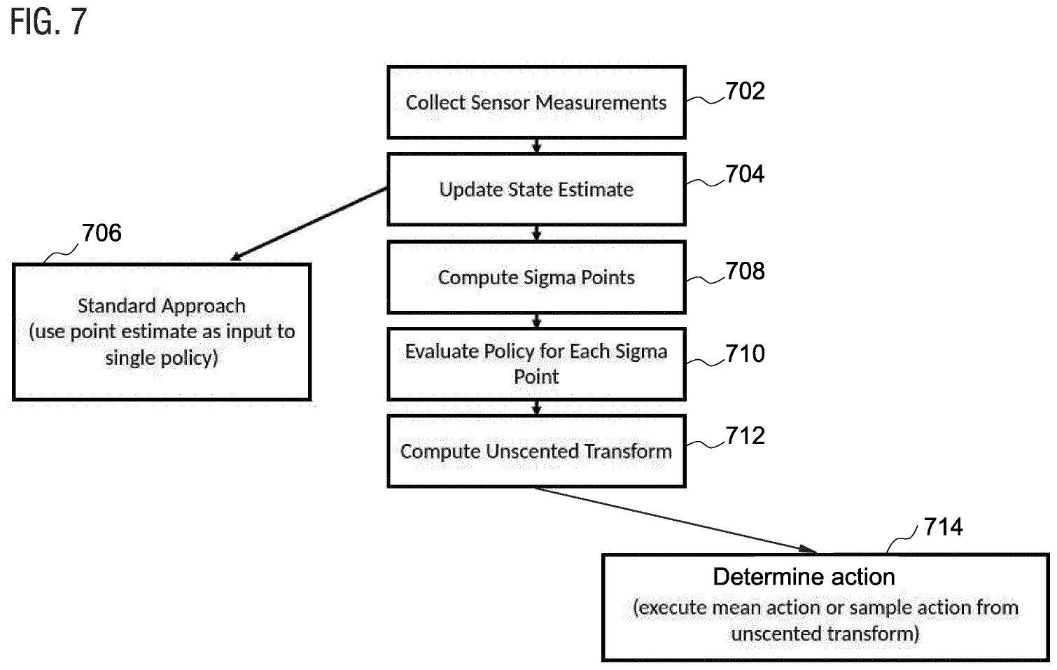

FIG. 7 shows a block diagram of a flowchart of an example implementation, in which after computing a distribution of actions using an unscented transform, the resulting estimate of uncertainty is used to select an action that accounts for the state estimate uncertainty. FIG. 7 shows to collect sensor measurements 702 at the top, which corresponds to the above obtaining 12 of the information on the environmental measurement results. From there, a state estimate for the environment is updated in 704, which corresponds to the above estimating 14 of the information on the state of the environment. As further indicated in FIG. 7 at this points the standard approach would be to use the point estimate of the environmental state as input to a single policy. In the example shown in FIG. 7 a set of sigma points is computed 708, which correspond to the above determining 16 of the representation for the state of the environment comprising two or more intermediary states representing the state of the environment and the confidence of the state of the environment. Policies can now be evaluated for each sigma point 710 and an unscented transform can be computed 712. A mean action or a sample action can be executed 714 from the unscented transform, which corresponds to the above determining 18 of the information on the action based on the intermediary actions. The determining 18 of the information on the action is based on the confidence information of the intermediary actions.

Examples may improve safety in the real world. A wrong choice of action by a learned policy may have severe consequences as the physical systems controlled by such policies can cause significant damage (e.g., with industrial robots in a factory) or even present a danger to their environment (e.g., with autonomous drones, or autonomous cars). In many cases, it is thus preferrable to implement a safe action (such as an emergency stop), when the uncertainty over the action is too large, cf. FIG. 7. By using the unscented policy transform this uncertainty in the actions can be quantified for the policy and it can be used as a threshold for execution. Note that learned policies are often nonlinear, a large uncertainty of the action does not necessarily correspond to a large uncertainty over the state.

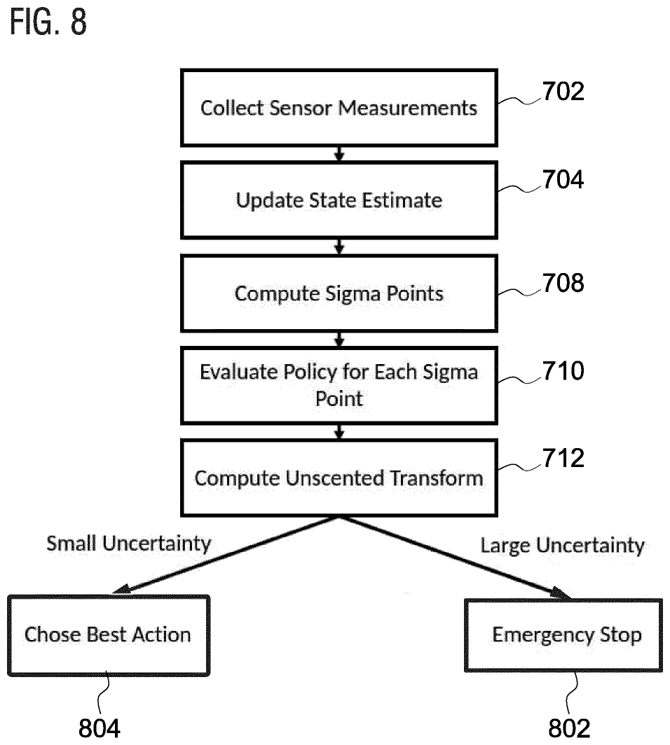

FIG. 8 shows a block diagram of a flowchart of an example implementation, in which after computing a distribution of actions using an unscented transform, the resulting estimate of uncertainty is used to trigger an emergency stop. In the flow chart of FIG. 8 the first steps 702-712 are the same as in FIG. 7. Once the distribution and therewith the uncertainty on the intermediary actions is known, decision can be made based on said uncertainty. For example, if the uncertainty is large an emergency stop 802 may result whereas if the uncertainty is small the best action can be chosen 804. Generally, in examples, the method 10 may further comprise determining information on a safety action as information on the action if the confidence information for the intermediary actions indicates confidence levels of the intermediary actions below a predefined confidence threshold.

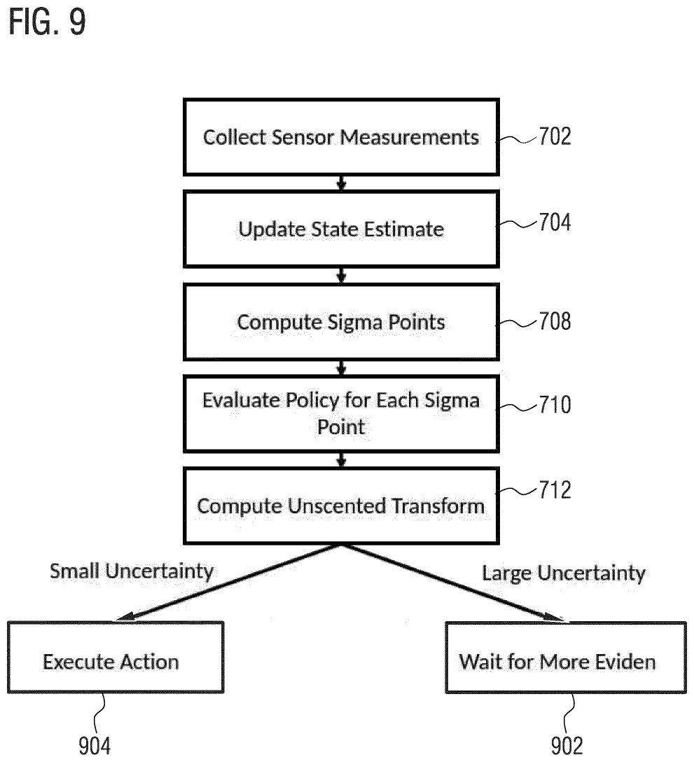

Examples may allow deciding when to act. In a way similar to improving safety, the unscented policy transform may be used to decide when to execute an action. This is particularly important in scenarios, where there is high uncertainty in the state estimate and a high degree of confidence in the outcome of an action is desired. By waiting until the uncertainty in the distribution of actions is below a certain level, there is a way of measuring whether enough evidence has been accumulated for the state estimate. This is advantageous when there is a high cost in changing the action online or when the state is estimated from multiple sources that all contribute to the level of uncertainty over different time scales. FIG. 9 shows yet another block diagram of a flowchart of an example implementation, in which after computing a distribution of actions using an unscented transform, the resulting estimate of uncertainty is used to decide whether to commit to an action or wait for more state evidence. The first steps 702-712 in the flow chart shown in FIG. 9 are the same as described above for FIG. 7. As further shown, if the uncertainty is small an action may be executed 904 and if the uncertainty is large step 902 waits for more evidence, i.e. for the uncertainty to decrease.

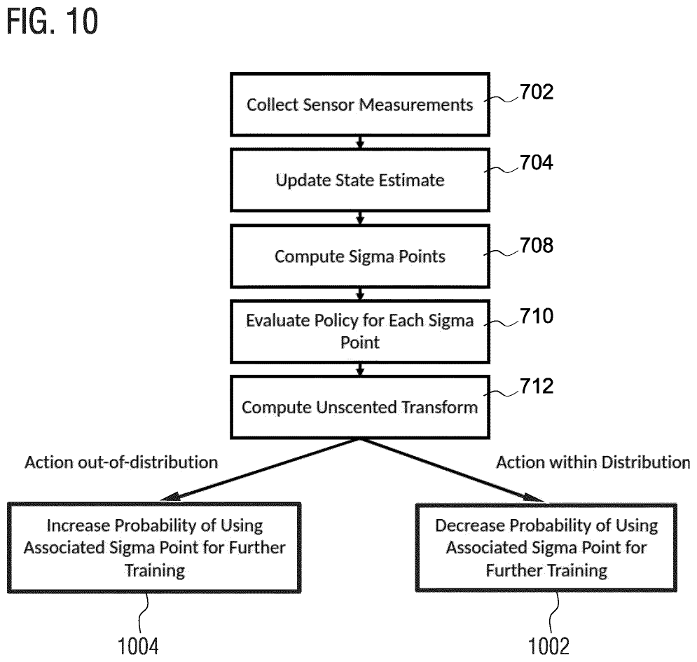

Examples may enable automatic curriculum learning. An efficient training curriculum can be constructed by biasing training towards regions of the state space that elicit substantially different action predictions to the surrounding neighborhood. By using the unscented policy transform sigma points can be identified that produce actions which lay far outside the general distribution of actions or that lie outside the predicted manifold of actions. The state estimates responsible for these actions can then be used to bias further training of the original policy network. This can also be viewed as a form of adversarial training via the unscented policy transform. FIG. 10 shows a block diagram of a flowchart of an example implementation, in which after computing a distribution of actions using an unscented transform, actions that lie outside of the resulting distribution are used to bias further training of the policy. The first steps 702-712 in the flow chart shown in FIG. 10 are the same as described above for FIG. 7. As further shown in FIG. 10 depending on whether an action lies out of the distribution or within the distribution different modifications of the training data result. If an action lies within the distribution, a probability of using an associated sigma point for further training may be decreased 1002. If an action lies out-of-distribution a probability of using the associated sigma point may be increased 1004.

Hence, the method 10 may further comprise training the policies, wherein the training of the policies is influenced by intermediary states identified for intermediary actions exhibiting a predefined statistical characteristic. For example, the predefined statistical characteristic is a confidence or uncertainty threshold.

In examples the automated device may be an autonomous vehicle or an industrial robot. The action may be a controlled action for the autonomous vehicle or the industrial robot. For example, the action may comprise one or more elements of the group of a maneuver, a motion, an acceleration, a deceleration, a steering command, a stop command (an emergency stop command), and an emergency command.

In the following some examples are summarized:

(1) A method for determining an action for an automated device based on a state of an environment of the automated device. The method comprises obtaining information on environmental measurement results, the measurement results having a limited confidence; estimating information on a state of the environment based on the information on the environmental measurement results, the information on the state of the environment comprising information on a confidence of the state of the environment; determining a representation for the state of the environment based on the information on the state of the environment and based on the information on the confidence of the state of the environment, the representation of the state of the environment comprising two or more intermediary states representing the state of the environment and the confidence of the state of the environment; and determining information on the action for the automated device based on the representation.

(2) The method of (1) comprising determining confidence information for the action.

(3) The method of one of (1) or (2), wherein each of the two or more intermediary states comprises one or more sigma points representing statistical properties of the information on the state of the environment.

(4) The method of one of (1) to (3), further comprising using one or more policies to obtain two or more intermediary actions based on the two or more intermediary states.

(5) The method of (4), further comprising using the same policy to obtain one intermediary action for each of the intermediary states.

(6) The method of one of (4) or (5), wherein the one or more policies involve a non-linear transform to obtain the two or more intermediary actions based on the two or more intermediary states.

(7) The method of one of (4) to (6), further comprising determining statistical properties of a distribution of the two or more intermediary actions.

(8) The method of (7), further comprising using an unscented transform for determining the statistical properties of the two or more intermediary actions.

(9) The method of one of (7) or (8), wherein the determining of the information on the action is further based on the statistical properties of the distribution of the two or more intermediary actions, and wherein the statistical properties of the distribution of the two or more intermediary actions comprise confidence information on the intermediary actions.

(10) The method of (9), wherein the determining of the information on the action is based on the confidence information of the intermediary actions.

(11) The method of one of (9) or (10), further comprising determining information on a safety action as information on the action if the confidence information for the intermediary actions indicates confidence levels of the intermediary actions below a predefined confidence threshold.

(12) The method of one of (9) to (11), further comprising training the policies, wherein the training of the policies is influenced by intermediary states identified for intermediary actions exhibiting a predefined statistical characteristic.

(13) The method of (12), wherein the predefined statistical characteristic is a confidence threshold.

(14) The method of one of (1) to (13), wherein the automated device is an autonomous vehicle or an industrial robot and wherein the action is a controlled action for the autonomous vehicle or the industrial robot.

(15) The method of (14), wherein the action comprises one or more elements of the group of a maneuver, a motion, an acceleration, a deceleration, a steering command, a stop command, and an emergency command.

(16) A computer program having a program code for performing a method according to any one of (1) to (15), when the computer program is executed on a computer, a processor, or a programmable hardware component.

(17) An apparatus for controlling an automated device comprising a control unit or module for performing one of the methods of one of (1) to (15).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method for determining an action for an automated device based on a state of an environment of the automated device, the method comprising
obtaining information on environmental measurement results, the measurement results having a limited confidence;
estimating information on a state of the environment based on the information on the environmental measurement results, the information on the state of the environment comprising information on a confidence of the state of the environment;
determining a representation for the state of the environment based on the information on the state of the environment and based on the information on the confidence of the state of the environment, the representation of the state of the environment comprising two or more intermediary states representing the state of the environment and the confidence of the state of the environment; and
determining information on the action for the automated device based on the representation.

2. The method of claim 1, further comprising determining confidence information for the action.

3. The method of claim 1, wherein each of the two or more intermediary states comprises one or more sigma points representing statistical properties of the information on the state of the environment.

4. The method of claim 1, further comprising using one or more policies to obtain two or more intermediary actions based on the two or more intermediary states.

5. The method of claim 4, further comprising using the same policy to obtain one intermediary action for each of the intermediary states.

6. The method of claim 5, wherein the one or more policies involve a non-linear transform to obtain the two or more intermediary actions based on the two or more intermediary states.

7. The method of claim 6, further comprising determining statistical properties of a distribution of the two or more intermediary actions.

8. The method of claim 7, further comprising using an unscented transform for determining the statistical properties of the two or more intermediary actions.

9. The method of claim 8, wherein the determining of the information on the action is further based on the statistical properties of the distribution of the two or more intermediary actions, and wherein the statistical properties of the distribution of the two or more intermediary actions comprise confidence information on the intermediary actions.

10. The method of claim 9, wherein the determining of the information on the action is based on the confidence information of the intermediary actions.

11. The method of claim 10, further comprising determining information on a safety action as information on the action if the confidence information for the intermediary actions indicates confidence levels of the intermediary actions below a predefined confidence threshold.

12. The method of claim 11, further comprising training the policies, wherein the training of the policies is influenced by intermediary states identified for intermediary actions exhibiting a predefined statistical characteristic.

13. The method of claim 12, wherein the predefined statistical characteristic is a confidence threshold.

14. The method of claim 13, wherein the automated device is an autonomous vehicle or an industrial robot and wherein the action is a controlled action for the autonomous vehicle or the industrial robot.

15. The method of claim 14, wherein the action comprises one or more elements of the group of a maneuver, a motion, an acceleration, a deceleration, a steering command, a stop command, and an emergency command.

16. A non-transitory computer readable medium storing a computer program having program code for performing the method according to claim 1, when the computer program is executed on a computer, a processor, or a programmable hardware component.

17. An apparatus for controlling an automated device comprising a control module for performing the method of claim 1.
